(19) United States
(12) Patent Application Publication
(10) Pub. No.: US 2013/0248096 A1
(43) Pub. Date: Sep. 26, 2013

(54) Molded-In-Color Panel And Method For Molding

(71) Applicant: FORD GLOBAL TECHNOLOGIES, LLC, Dearborn, MI (US)

(72) Inventors: LaRon Borwn, Detroit, MI (US); Kedzie Fernholz, New Boston, MI (US); Stanley Staniszewski, Grosse Pointe Woods, MI (US)

(73) Assignee: Ford Global Technologies, LLC, Dearborn, MI (US)

(21) Appl. No.: 13/872,486

(22) Filed: Apr. 29, 2013

Related U.S. Application Data
(62) Division of application No. 11/766,813, filed on Jun. 22, 2007, now abandoned.

(51) Int. Cl. B29C 47/00

(52) U.S. Cl. CPC B29C 65/7473
USPC 156/245; 156/379.8

(57) ABSTRACT

In one embodiment, a method for molding a molded-in-color panel in a mold includes providing a mold having a first mold member and a second mold member. One of the first mold member and the second mold member has an appearance portion forming surface and the other of the first mold member and the second mold member has a concealed portion forming surface corresponding with the appearance portion forming surface. The concealed portion forming surface forms a concealed portion of a panel and is free of any protuberances and ancillary structural members for facilitating ideal surface characteristics of an appearance portion of the panel. Molded-in-color resin is injected in the mold and cooled to form a molded-in-color panel. At least one ancillary structural member is welded to the concealed portion of the panel.

### CROSS-REFERENCE TO RELATED APPLICATIONS

This application is a divisional of U.S. Application Ser. No. 11/766,813 filed Jun. 22, 2007, the disclosure of which is incorporated in its entirety by reference herein.

### TECHNICAL FIELD

The multiple embodiments of the present invention relate to molded-in-color panels and molds for creating molded-in-color panels.

### BACKGROUND

Vehicle panels are an example of molded-in-color panels. Vehicle panels may be on the interior or exterior of a vehicle, commonly have surfaces, which are exposed to a viewable environment. These exposed surfaces are often referred to as class-A surfaces. It is desirable to create these class-A surfaces to have few or no surface defects or flaws when compared to non class-A surfaces. Since class-A surfaces are exposed to a viewable environment, these surfaces are formed using tighter tolerances and greater detail. Non class-A surfaces are not exposed in the viewable environment and may have visible surface defects and flaws.

Vehicle panels with class-A surfaces are not typically injection-molded or compression-molded unless the vehicle panels are painted in a secondary painting operation, covering surface defects. Painting the vehicle panel in a secondary painting operation requires additional time and cost to create the vehicle panel. Paint is also susceptible to peeling, chipping, blistering and/or delamination.

Molded-in-color plastics are a lower cost option for programs to consider instead of current painted technologies and/or other decorative alternatives, such as paint film or other laminates. Molded-in-color plastics are also environmentally friendly because molded-in-color plastics do not require a secondary painting process so molded-in-color plastics may be easily recycled and manufacturing of molded-in-color plastics does not generate volatile organic compounds.

### SUMMARY

A method for creating a molded-in-color panel in a mold is disclosed. The method includes providing a mold having a first mold member and a second mold member. One of the first mold member and the second mold member has an appearance portion forming surface and the other of the first mold member and the second mold member has a concealed portion forming surface corresponding with the appearance portion forming surface. The concealed portion forming surface forms a concealed portion of a panel and is free of any protuberances and ancillary structural members for facilitating ideal surface characteristics of an appearance portion of the panel. Molded-in-color resin is injected in the mold and cooled to form a molded-in-color panel. At least one ancillary structural member is welded to the concealed portion of the panel.

In another embodiment, a molded-in-color panel is disclosed. The molded-in-color panel is formed providing a mold having a first mold member and a second mold member. One of the first mold member and the second mold member has an appearance portion forming surface and the other of the first mold member and the second mold member has a concealed portion forming surface corresponding with the appearance portion forming surface for forming a concealed portion of a panel. The concealed portion forming surface is free of any protuberances and ancillary structural members for facilitating ideal surface characteristics of an appearance portion of the panel. Molded-in-color resin is injected in the mold and the molded-in-color resin is cooled to form a molded-in-color panel. At least one ancillary structural member is welded to the concealed portion of the panel.

In another embodiment, a system for creating a molded-in-color element in a mold is disclosed. The system has an injection molding machine having a first mold member and a second mold member. One of the first mold member and the second mold member has an appearance portion forming surface and the other of the first mold member and the second mold member has a concealed portion forming surface corresponding with the appearance portion forming surface for forming a concealed portion of a panel. The concealed portion forming surface is free of any protuberances and ancillary structural members for facilitating ideal surface characteristics of an appearance portion of the panel. Molded-in-color resin can be injected in the mold at a sufficient flow rate so that the molded-in-color resin flows without disruption over the first mold member and second mold member to form a molded-in-color element to facilitate ideal surface characteristics of the appearance portion of the molded-in-color element. The system includes a laser welding station to weld at least one accessory on the molded-in-color element.

### BRIEF DESCRIPTION OF THE DRAWINGS

FIG. 1 is a side elevation view of a mold;

FIG. 2 is top plan view of the mold of FIG. 1;

FIG. 3 is a cross-section view of the mold of FIG. 2 taken along line 3-3 and a welding station;

FIG. 4 is a schematic view of a welding station embodiment for joining a panel and a structural component together;

FIG. 5 is a cross-section view of a panel formed in the mold of FIG. 3 and a plurality of structural components;

FIG. 6 is another cross-section view of the panel and the plurality of structural components of FIG. 5 joined together; and

FIG. 7 is a partial cross-section view of a panel joined together with a structural component.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Molded-in-color panels may be formed using injection-molding or compression-molding. When forming molded-in-color panels, creating class-A surfaces results in a visible appearance of knit lines, mold flow lines, and sink marks. Although molded-in-color plastics offer benefits, it is still extremely difficult to mold parts in color without visible appearance of knit lines, flow lines or sink marks on a class-A surface. In addition, when metallic molded-in-color resin is utilized, creating a defect-free class-A surface is extremely difficult because metallic molded-in-color resin has a high propensity for surface defects.

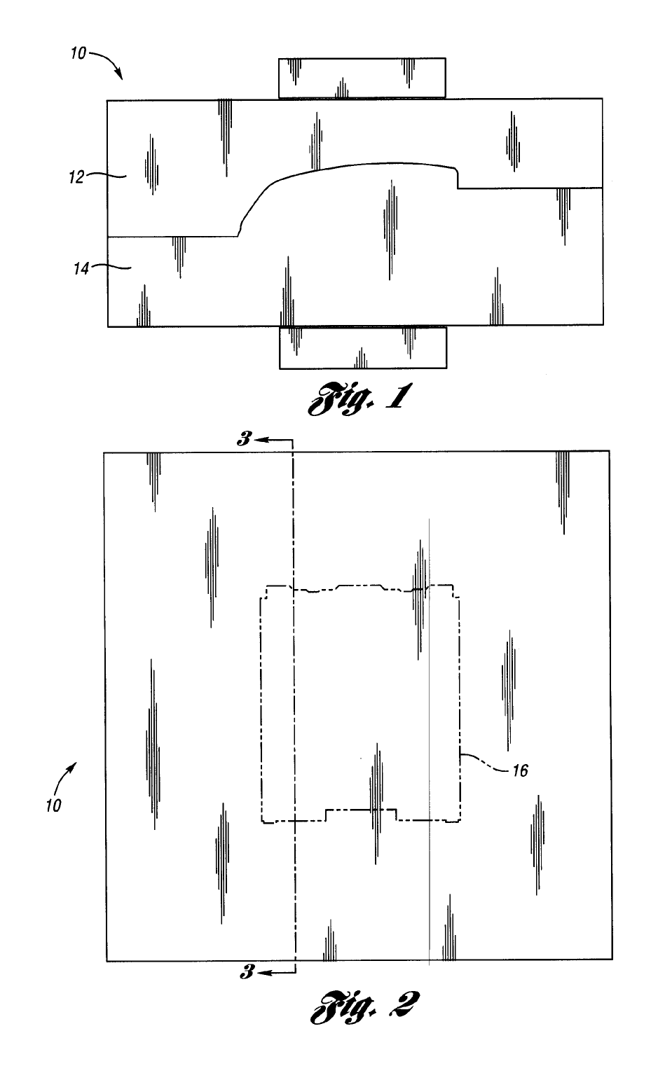

Referring now to FIG. 1, a mold for creating a molded-in-color panel is illustrated and referenced generally by numeral 10. The panel 10 may be any suitable molded-in-color panel 10. In one embodiment, the panel 10 is a vehicle panel 10, which is employed on an interior or exterior of a vehicle. Of course, any molded-in-color panel 10 is contemplated within the scope of the present invention. The mold 10 has a first mold half 12 and a second mold half 14. In another embodiment, the mold 10 may have three or more mold portions, which collectively form the mold 10. Any number of mold portions is contemplated within the scope of the present invention.

In one embodiment, the first mold half 12 is referred to as a cavity because the first mold half 12 may have a substantial recess for receiving the second mold half 14. The second mold half 14 is referred to as a core because the second mold half 14 has a substantial projection which is received in the cavity 12.

The core 14 may be moveable relative to the cavity 12. By providing a stationary cavity 12 and a moveable core 14, a vehicle panel may be retained within the mold 10 on the core 14 after molding the vehicle panel, which may be generally easily ejected or removed after the mold 10 is opened. It is also contemplated within the scope of the invention that the cavity 12 may be moveable while the core 14 is stationary. If three or more mold portions are employed, at least one mold portion may be moveable relative to at least a second mold portion.

Referring now to FIG. 2, a top plan view of the mold 10 of FIG. 1 is illustrated. To create a vehicle panel 16, a heated resin is injected into the mold 10 through a resin inlet. In one embodiment, the resin inlet is a gate.

The heated resin has molded-in-color so that a secondary painting operation is not required. In one embodiment, the heated resin and the colorant may be separately injected into the mold 10. The resin may have material properties comparable with a thermoplastic polyolefin (TPO) or a polycarbonate-acrylonitrile butadiene styrene (PC/ABS).

The resin may contain metallic molded-in-color for vehicle panel applications for use in the interior of the vehicle, for example. Using a metallic molded-in-color resin in a typical mold creates large amounts of surface defects, which are not visually appealing. The metallic molded-in-color resin may achieve a low gloss, quality, metallic appearance once injection-molded or compression-molded. The resulting vehicle panel delivers an enhanced metallic appearance over paint and offers a low-cost option to using aluminum and/or decorative films.

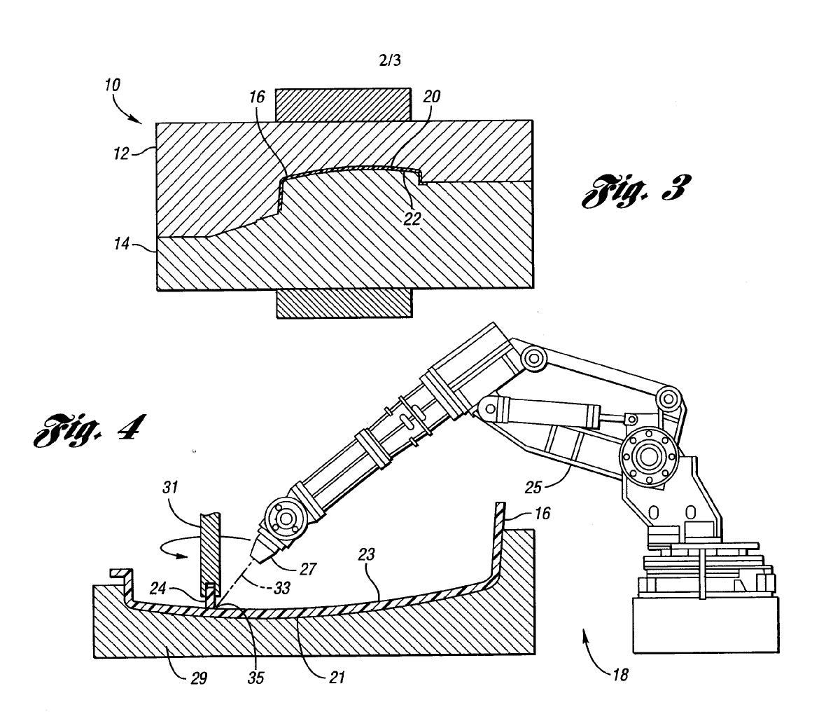

Referring now to FIG. 3, the mold 10 of FIG. 2 is illustrated in cross-section taken along line 3-3. The mold 10 has a cavity 12, which is stationary, and a core 14, which is moveable relative to the cavity 12. The cavity 12 may also be moveable relative to the core 14. The mold 10 is illustrated in a closed position while a vehicle panel 16 is being formed. The first forming surface 20 of the cavity 12 and the second forming surface 22 collectively provide an outer boundary for the vehicle panel 16.

The cavity 12 has a first forming surface 20 for cooperating with a second forming surface 22 of the core 14. In another embodiment, three or more forming surfaces are provided to collectively define the outer boundary of a vehicle panel. Heated resin flows over the first forming surface 20 and the second forming surface 22 to fabricate a vehicle panel. The heated resin may be introduced into the mold 10 in any suitable known manner.

As depicted, the second forming surface 22 of the core 14 is free of any protuberances such as ancillary structural elements, any features that are not required for an appearance of an exposed, visible side 21 of the vehicle panel 16 or any changes in a concealed side 23 without corresponding changes in the exposed, visible side 21. The protuberance free second forming surface 22 allows heated resin to freely flow over the second forming surface 22 without disturbance. Since the heated resin flows without disturbance over the second forming surface 22, the vehicle panel 16 formed in the mold 10 is free of visible knit lines, flow lines and sink marks on an exposed, visible side 21 of the vehicle panel 16. Ideal surface characteristics for the exposed, visible side 21 are desired so that the vehicle panel 16 is visually pleasing.

The vehicle panel 16 formed in the mold 10 has an exposed, visible side 21 and a concealed side 23. The exposed, visible side 21 is visible when mounted on a vehicle. To produce the visually pleasing vehicle panel 16, the design of the second forming surface 22 eliminates all protuberances formed in the second forming surface 22, including any ancillary structural elements. Examples of ancillary structural elements include, but are not limited to, brackets, ribs, gussets, bosses, connecting members, retention members, fasteners, and/or push-pins. The ancillary structural elements are separately formed and welded to the vehicle panel at a welding station, which is illustrated in FIG. 4 and generally referenced by numeral 18.

Referring to FIG. 4, a laser welding station 18 is illustrated as one example of a welding station. Of course, any suitable welding station is contemplated within the scope of the present invention. The laser welding station 18 has a robot 25 to support a laser welding end effecter 27. The laser welding station 18 has a first weld fixture 29 to support a vehicle panel 16 and a second weld fixture 31 to support an ancillary structural component 24. The invention contemplates any suitable first and second weld fixtures 29, 31. The laser end effecter 27 on the robot 25 produces a laser beam 33 to produce a weld zone 35 between the vehicle panel 16 and the ancillary structural component 24. The laser 27 may rotate about the second weld fixture 31, as indicated by an arcuate arrow, to adequately join the vehicle panel 16 and the ancillary structural component 24.

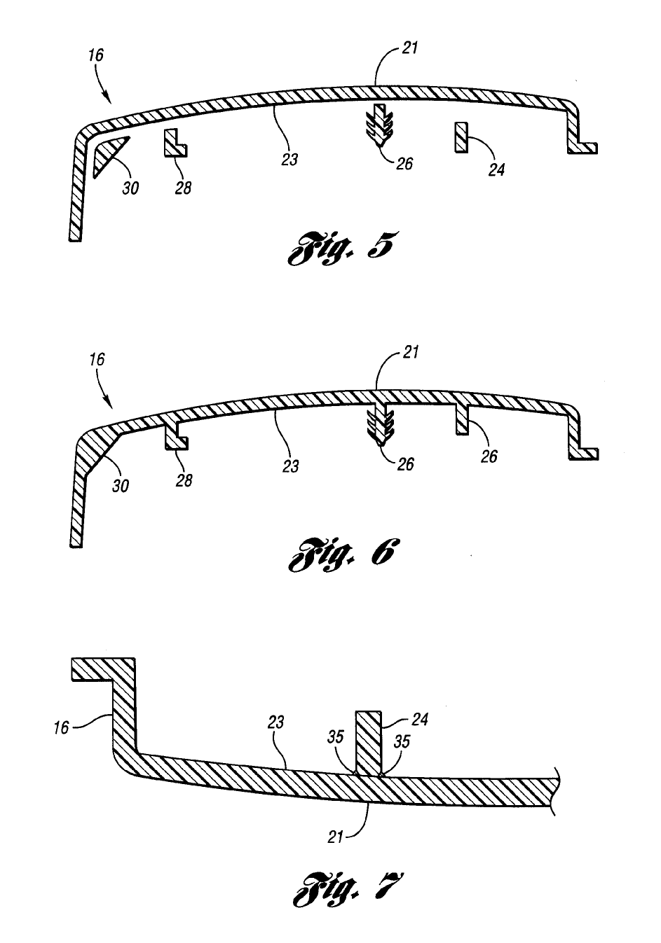

With reference to FIG. 5, a vehicle panel 16 formed in the mold 10 of FIGS. 1-3 and ancillary structural components 24-30 are illustrated. In one embodiment, the ancillary structural component is a rib 24, which extends along a length of the vehicle panel 16. In another embodiment, the ancillary structural component is a connecting member 24 to connect the vehicle panel 16 to the vehicle once the connecting member 24 is welded to the vehicle panel 16.

An additional ancillary structural component 26 is illustrated as a push-pin 26. The push-pin 26 facilitates retention of the vehicle panel 16 on a vehicle once the push-pin 26 is welded to the vehicle panel 16. Another ancillary structural component 28 is depicted as a bracket 28. The bracket 28 is utilized to removably attach the vehicle panel 16 to a vehicle once the bracket 28 is welded to the vehicle panel 16. Yet another ancillary structural component 30 is illustrated as a gusset 30. The gusset 30 supports a corner of the vehicle panel 16 once the gusset 30 is welded to the vehicle panel 16. Any amount of ancillary structural components 24 is contemplated within the scope of the present invention.

As discussed above, the vehicle panel 16 is formed free of protuberances on the concealed side 23 to facilitate ideal surface characteristics on the exposed, visible side 21. Since the vehicle panel 16 is formed without protuberances on the concealed side 23, the ancillary structural components 24-30 are not integrally formed with the vehicle panel 16.

In one embodiment, the ancillary structural components 24-30 are individually molded. The ancillary structural components 24-30 may be injection-molded, compression-molded, vacuum-molded or extruded. The ancillary structural components 24-30 may be fabricated in any suitable known manner so that the ancillary structural components 24-20 may be welded to the vehicle panel 16.

The ancillary structural components 24-30 may be, but are not limited to being brackets, ribs, gussets, bosses, connecting members, retention members, fasteners, and/or push-pins. Any known ancillary structural components 24-30 may be utilized within the scope of the present invention. In one embodiment, a plurality of structural components 24-30 are provided and the plurality of structural components 24-30 are all welded to the vehicle panel 16. The ancillary structural components 24-30 may be all identical, may differ in size and/or shape, or may be varying amounts of differing types altogether of ancillary structural components 24-30.

In one embodiment, the ancillary structural components 24-30 are formed while the vehicle panel 16 is produced. In another embodiment, the ancillary structural components 24-30 are fabricated at a different time and/or place from the vehicle panel 16. The vehicle panel 16 is suitably transported from the mold 10 to the welding station 18, as illustrated in FIG. 4. The ancillary structural components 24-30 are transported to the welding station 18 where the ancillary structural components 24-30 are welded to the vehicle panel 16. In one embodiment, the ancillary structural components 24-30 are laser welded to the vehicle panel 16. In another embodiment, the ancillary structural components 24-30 are friction welded to the vehicle panel. Any known laser welding, friction welding or other thermoplastic joining station may be utilized so that the vehicle panel 16 and the ancillary structural components 24-30 are joined together, as depicted in FIG. 6. Any known manner of joining preformed ancillary structural components 24-30 to the preformed vehicle panel 16 is contemplated within the scope of the present invention.

To weld the vehicle panel 16 and the ancillary structural components 24-30 together, both the vehicle panel 16 and the ancillary structural components 24-30 should have overlapping melting temperatures. In one embodiment, the overlapping melting temperatures of the vehicle panel 16 and the ancillary structural components 24-30 correspond with a temperature the welding station produces when the vehicle panel 16 and ancillary structural components 24-30 are placed under a laser of the laser welding station for a specified period of time.

Referring now to FIG. 7, a partial view of a vehicle panel 16 is illustrated joined together with an ancillary structural component 24. A weld zone 35 exists between the vehicle panel 16 and the ancillary structural component 24 that does not disrupt the exposed, visible side 21 of the vehicle panel 16. An adequate penetration weld may be employed so that the weld does not alter the finish of an exposed, visible side 21 of the vehicle panel 16.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method for molding a molded-in-color panel comprising:
providing a mold having a first mold member and a second mold member wherein one of the first mold member and the second mold member has an appearance portion forming surface and the other of the first mold member and the second mold member has a concealed portion forming surface corresponding with the appearance portion forming surface for forming a concealed portion of a panel, the concealed portion forming surface being free of any protuberances and ancillary structural members for facilitating ideal surface characteristics of an appearance portion of the panel;
injecting molded-in-color resin in the mold;
cooling the molded-in-color resin to form a molded-in-color panel; and
welding at least one ancillary structural member to the concealed portion of the panel.

2. The method of claim 1 further comprising injecting molded-in-color metallic resin.

3. The method of claim 1 further comprising laser welding the at least one ancillary structural member to the concealed portion of the molded-in-color panel.

4. The method of claim 1 further comprising injection molding the at least one ancillary structural member prior to welding the at least one ancillary structural member to the concealed portion of the molded-in-color panel.

5. The method of claim 1 further comprising ejecting the molded-in-color panel before welding the at least one ancillary structural member to the concealed portion of the molded-in-color panel.

6-8. (canceled)

9. The method of claim 1 further comprising cooling the molded-in-color resin to form a molded-in-color exterior panel.

10-18. (canceled)

19. A system for manufacturing a molded-in-color element in a mold, the system comprising:
an injection molding machine having a first mold member and a second mold member wherein one of the first mold member and the second mold member has an appearance portion forming surface and the other of the first mold member and the second mold member has a concealed portion forming surface corresponding with the appearance portion forming surface for forming a concealed portion of a panel, the concealed portion forming surface being free of any protuberances and ancillary structural members for facilitating ideal surface characteristics of an appearance portion of the panel such that metallic molded-in-color resin is injected in the mold at a sufficient flow rate so that the metallic molded-in-color resin flows without disruption over the first mold member and second mold member to form a molded-in-color element for facilitating substantially ideal surface characteristics of the appearance portion of the metallic molded-in-color element; and
a laser welding station to weld at least one accessory on the molded-in-color element.

20. The system of claim 19 wherein the metallic molded-in-color element is further defined as a metallic molded-in-color exterior panel.

21. The method of claim 1 further comprising providing at least one of the first and second mold members with a contoured surface so that the concealed portion of the panel has a contoured surface.

22. The method of claim 1 further comprising providing an additional structural member separate from the at least one ancillary structural member and laser welding the additional structural member to the concealed portion of the panel.

23. The method of claim 1 further comprising forming a weld zone between the at least one ancillary structural member and the concealed portion of the panel.

24. A method for molding a molded-in-color panel comprising:
providing a mold having a first mold member and a second mold member wherein one of the first mold member and the second mold member has an appearance portion forming surface and the other of the first mold member and the second mold member has a concealed portion forming surface corresponding with the appearance portion forming surface for forming a concealed portion of a panel, the concealed portion forming surface being free of any protuberances and ancillary structural members for facilitating ideal surface characteristics of the appearance portion of the panel such that the appearance portion of the panel is free of visible appearance of knit lines, flow lines and sink marks;
injecting molded-in-color resin in the mold;
cooling the molded-in-color resin to form a molded-in-color panel;
providing at least one ancillary structural member formed separately as a protrusion; and
laser welding the at least one ancillary structural member to the concealed portion of the panel along the protrusion.

25. The method of claim 24 further comprising providing at least one of the first and second mold members with a the concealed portion of the panel has a contoured surface.

26. The method of claim 24 further comprising providing an additional ancillary member separate from the at least one ancillary member and laser welding the additional structural member to the concealed portion of the panel.

27. The method of claim 24 further comprising injection molding the at least one ancillary structural member and the additional structural member as separate components prior to welding the at least one ancillary structural member and the additional structural member to the contoured concealed portion of the molded-in-color panel.

28. The method of claim 24 further comprising forming a weld zone between the at least one ancillary structural member and the concealed portion of the panel.

29. The method of claim 24 wherein a weld zone is formed between the at least one ancillary structural member and the concealed portion of the panel.

30. The method of claim 24 further comprising providing at least one of the first and second mold members with a contoured surface so that the concealed portion of the panel has a contoured surface.

31. The method of claim 24 further comprising providing one of the first mold member and the second mold member with a contoured appearance portion forming surface and the other of the first mold member and the second mold member with a contoured concealed portion forming surface corresponding with the contoured appearance portion forming surface for forming a contoured concealed portion of a panel.

32. The method of claim 24 further comprising further comprising injection molding the at least one ancillary structural member to the i prior to welding the at least one ancillary structural member and the additional structural member to the contoured concealed portion of the molded-in-color panel.
